(19) United States
(12) Patent Application Publication
(10) Pub. No.: US 2026/0158474 A1
(43) Pub. Date: Jun. 11, 2026

(54) METHOD FOR FABRICATION AND TRANSFER OF HARD-TO-TRANSFER METAL NANOSTRUCTURED CATALYSTS, AND METAL NANOSTRUCTURED CATALYSTS FABRICATED BY USING THE SAME

(71) Applicant: Korea Advanced Institute of Science and Technology, Daejeon (KR)

(72) Inventors: Yeonsik JUNG, Daejeon (KR); Siyeon KIM, Daejeon (KR); Gyurac LEE, Daejeon (KR)

(73) Assignee: Korea Advanced Institute of Science and Technology, Daejeon (KR)

(21) Appl. No.: 19/399,998

(22) Filed: Nov. 25, 2025

(30) Foreign Application Priority Data
Dec. 6, 2024 (KR) 10-2024-0180278
Sep. 15, 2025 (KR) 10-2025-0132147

(51) Int. Cl. B01J 23/72; B01J 23/52; B01J 37/02; B01J 37/08

(52) U.S. Cl. CPC B01J 23/72; B01J 23/52; B01J 37/0215; B01J 37/08

(57) ABSTRACT

The disclosed metal nanostructured catalysts are fabricated by forming a nanostructure in which a plurality of metal nanowires containing a metal are aligned on a substrate, forming a protective layer including an organic material on the nanostructure, forming a groove adjacent to the nanostructure on one surface of the substrate on which the nanostructure is formed, and applying an etching solution on the one surface of the substrate to fill the groove and separating the nanostructure from the substrate.

### CROSS-REFERENCE TO RELATED APPLICATION(S)

This application claims priority under 35 U.S.C. § 119 to Korean Patent Application No. 10-2024-0180278, filed on Dec. 6, 2024 and No. 10-2025-0132147, filed on Sep. 15, 2025 which are hereby incorporated by reference for all purposes as if fully set forth herein.

### BACKGROUND

### 1. Field

Embodiments relate to a method for fabrication and transfer of hard-to-transfer metal nanostructured catalysts and metal nanostructured catalysts fabricated by suing the same. More particularly, the embodiments relate to the method for fabrication and transfer of hard-to-transfer metal nanostructured catalysts used as a carbon dioxide reduction reaction catalyst and metal nanostructured catalysts fabricated by suing the same

### 2. Description of the Related Art

Reducing carbon dioxide emissions is a long-standing global challenge aimed at lowering dependence on oil resources and addressing environmental issues. Carbon dioxide may be converted into an eco-friendly energy source or a chemical feedstock through reduction reactions. However, to decompose carbon dioxide, which is chemically very stable, the development of highly efficient and highly selective catalysts is essential. Recently, a transfer method using metal nanostructured catalysts has been employed to fabricate highly efficient electrochemical nano-catalysts based on a substrate.

To evaluate the catalytic performance of the carbon dioxide reduction reaction, nano-catalysts may be formed on a gas diffusion layer (GDL). The gas diffusion layer may be a type of carbon paper having a very rough surface and may be coated with a polymer such as fluorene-based polytetrafluoroethylene (PTFE) to ensure stable reactions in aqueous electrolytes.

Meanwhile, to generate high-value-added compounds containing two or more carbon atoms in the carbon dioxide reduction reaction, copper (Cu), which is a transfer-resistant metal, may be essential as a catalyst material having appropriate bonding energy with carbon and oxygen. In general, when transferring a nano-catalyst grown on a substrate to a carbon electrode, a copper etching solution may be used, which causes a problem in that it is difficult to use a catalyst material containing copper.

### SUMMARY

Embodiments provide a method for fabrication of hard-to-transfer metal nanostructured catalysts for implementing a high efficiency catalyst.

Embodiments provide a method for transfer of the hard-to-transfer metal nanostructured catalysts by using the same.

Embodiments provide the metal nanostructured catalysts through the method for fabrication and transfer.

A method for fabrication of hard-to-transfer metal nanostructured catalysts according to an embodiment includes forming a nanostructure including a plurality of metal nanowires aligned on a substrate, forming a protective layer including an organic material on the nanostructure, forming a groove adjacent to the nanostructure on one surface of the substrate on which the nanostructure is formed, and separating the nanostructure from the substrate by applying an etching solution on the one surface of the substrate to fill the groove.

In an embodiment, in the separating the nanostructure from the substrate, a portion of the substrate in contact with the nanostructure may be removed through the etching solution.

In an embodiment, the nanostructure may include copper (Cu), the substrate may be a silicon (Si) wafer substrate, and the etching solution may be an aqueous potassium hydroxide (KOH) solution.

In an embodiment, the substrate may be a silicon oxide (SiOₓ) wafer substrate, and the etching solution may be a buffered oxide etchant (BOE).

In an embodiment, in the forming the groove adjacent to the nanostructure, the groove may be formed to entirely surround a boundary of the protective layer in a plan view.

In an embodiment, in the forming the groove adjacent to the nanostructure, a shortest distance between the groove and a boundary of the protective layer in a plan view may be about 2 mm or less.

In an embodiment, the forming the nanostructure may include forming an acrylic resin on a master mold having a plurality of recessed patterns, forming a plurality of protruded patterns corresponding to the plurality of recessed patterns on the acrylic resin by separating the acrylic resin from the master mold, forming a first metal nanowire layer in which a plurality of metal nanowires are aligned on the plurality of protruded patterns of the acrylic resin, attaching the first metal nanowire layer to the substrate and removing the acrylic resin from the first metal nanowire layer, and alternately stacking a second metal nanowire layer including a material different from a material of the first metal nanowire layer on the substrate together with the first metal nanowire layer.

In an embodiment, each of the plurality of metal nanowires included in the first metal nanowire layer may include a gold (Au), and each of the plurality of metal nanowires included in the second metal nanowire layer may include a copper (Cu).

In an embodiment, a direction in which each of the plurality of metal nanowires included in the first metal nanowire layer extends and a direction in which each of the plurality of metal nanowires included in the second metal nanowire layer extends may form an angle of about 80°to about 90°in a plan view.

In an embodiment, in the forming the protective layer, the protective layer may be formed by coating the nanostructure with a solution including an acrylic resin having a weight ratio of about 3 wt % to about 5 wt % in a solvent in which the volume ratio of acetone, toluene, and heptane is about 4:4:2 to about 4.5:4.5:1.

In an embodiment, the protective layer may include at least one selected from a group consisting of a polymethyl methacrylate (PMMA), a methyl acrylate, an ethyl acrylate, a n-butyl acrylate, a t-butyl acrylate, and cellulose acetate.

In an embodiment, the method may further include performing a heat treatment on the nanostructure. The performing the heat treatment may be performed between the forming the nanostructure and the forming the groove

In an embodiment, in the performing the heat treatment, the heat treatment may be performed at a temperature range of about 500° C. to about 700° C. for about 5 minutes to 2 hours

A method for transfer of hard-to-transfer metal nanostructured catalysts according to an embodiment includes forming a nanostructure including a plurality of metal nanowires aligned on a substrate, forming a protective layer including an organic material on the nanostructure, forming a groove adjacent to the nanostructure on one surface of the substrate on which the nanostructure is formed, separating the nanostructure from the substrate by applying an etching solution on the one surface of the substrate to fill the groove, and attaching the separated nanostructure to a transfer target substrate.

In an embodiment, the attaching the separated nanostructure to a transfer target substrate may include introducing the nanostructure into a deionized water (DI water) solution, introducing the transfer target substrate into the deionized water solution so that the transfer target substrate is in contact with the nanostructure from below the nanostructure, and drying the nanostructure and the transfer target substrate.

In an embodiment, attaching the separated nanostructure to a transfer target substrate may further include surface treating the transfer target substrate so that hydroxyl groups are formed on the surface of the transfer target substrate before introducing the transfer target substrate into the deionized water solution.

In an embodiment, the substrate may be a silicon (Si) wafer substrate, and an etching solution may be an aqueous potassium hydroxide (KOH) solution.

In an embodiment, the nanostructure may include copper (Cu), the substrate may be a silicon oxide (SiOₓ) wafer substrate, and the etching solution may be a buffered oxide etchant.

In an embodiment, in the forming the groove adjacent to the nanostructure, the groove may be formed to entirely surround a boundary of the protective layer in a plan view.

A metal nanostructured catalysts according to an embodiment includes a first metal nanowire layer including a plurality of metal nanowires spaced apart from each other in a plan view and containing copper (Cu) and a second metal nanowire layer including a plurality of metal nanowires spaced apart from each other in a plan view and containing gold (Au). The first metal nanowire layer and the second metal nanowire layer are alternately stacked in multiple layers.

In a method for fabrication and transfer of hard-to-transfer metal nanostructured catalysts according to an embodiment of the present disclosure, a groove adjacent to a nanostructure may be formed on one surface of a substrate, and an etching solution that fills the groove may be applied. Accordingly, since a portion of the substrate in contact with the nanostructure may be removed by the etching solution diffused along the groove without immersing the substrate and the nanostructure into a container containing the etching solution, the substrate may be easily removed from the nanostructure. Therefore, process time and cost in obtaining the nanostructure used in a metal catalyst structure for carbon dioxide reduction may be reduced.

In addition, since the substrate may be easily removed by forming the groove, a substrate of a metal or metal oxide including copper, which is transfer-resistant, may be used. Accordingly, the type of substrate for fabricating the metal catalyst structure may not be limited, and since an etching solution for etching copper is not used, the nanostructure may include copper. Therefore, the high-efficiency and high-selectivity metal catalyst structure may be easily fabricated.

In addition, when the transfer target substrate is a gas diffusion layer having hydrophobicity, a surface treatment may be performed such that the surface of the transfer target substrate has hydroxyl groups. Accordingly, the nanostructure may be easily attached or transferred to the gas diffusion layer.

In addition, since the type of substrate that may be used to fabricate the metal catalyst structure may not be limited, heat treatment may be performed on the nanostructure before forming the groove. Accordingly, the crystallinity of the nanostructure may be improved. Therefore, a performance of the metal catalyst structure for carbon dioxide reduction fabricated from the nanostructure may be improved.

### BRIEF DESCRIPTION OF THE DRAWINGS

Illustrative, non-limiting embodiments will be more clearly understood from the following detailed description in conjunction with the accompanying drawings.

FIG. 1 is a flowchart illustrating a method for transfer of a metal nanostructured catalyst according to an embodiment of the present disclosure.

FIG. 2 is a diagram for explaining the method of transfer of the metal nanostructured catalyst of FIG. 1.

FIG. 3 is a plan view for explaining forming a groove on one surface of the substrate of FIG. 1.

FIG. 4 is a flowchart illustrating a method for forming a nanostructure on the substrate of FIG. 1.

FIG. 5 is a diagram for explaining the method for forming the nanostructure on the substrate of FIG. 1.

FIG. 6 is a diagram illustrating a method for transfer of the metal nanostructured catalyst according to another embodiment of the present disclosure.

FIG. 7 is a diagram illustrating a method for transfer of the metal nanostructured catalyst according to still another embodiment of the present disclosure.

FIG. 8 is a graph illustrating electrical characteristics of a fabrication example fabricated according to the method for fabrication and transfer of the metal nanostructured catalyst of the present disclosure.

FIG. 9 is a graph illustrating carbon dioxide reduction efficiency of the fabrication example of FIG. 8.

### DETAILED DESCRIPTION OF THE EMBODIMENTS

In the embodiments of the present disclosure described herein, specific structural or functional descriptions are merely illustrated for the purpose of explaining the embodiments of the disclosure, and the embodiments of the disclosure may be implemented in various forms and should not be construed as being limited to the embodiments described in the disclosure.

The disclosure may be modified in various ways and may take several forms, and specific embodiments are illustrated in the drawings and described in detail herein. However, this is not intended to limit the disclosure to the specific forms set forth, and it should be understood to include all modifications, equivalents, and substitutes that fall within the spirit and scope of the disclosure.

Terms such as first and second may be used to describe various components, but the components should not be limited by these terms. The terms may be used only to distinguish one component from another. For example, without departing from the scope of the disclosure, a first component may be referred to as a second component, and similarly, a second component may be referred to as a first component.

When it is stated that one component is “connected to” or “coupled to” another component, it should be understood that the component may be directly connected or coupled to the other component, or intervening components may be present therebetween. In contrast, when it is stated that one component is “directly connected to” or “directly coupled to” another component, it should be understood that no intervening component is present. Other expressions describing relationships between components, such as “between” and “directly between,” or “adjacent to” and “directly adjacent to,” should be interpreted in the same manner.

The terminology used in the disclosure is intended only to describe specific embodiments and is not intended to limit the disclosure. Unless the context clearly indicates otherwise, the singular forms include the plural forms as well. In the disclosure, terms such as “comprise” or “have” indicate the presence of stated features, numbers, steps, operations, elements, parts, or combinations thereof, but do not preclude the presence or addition of one or more other features, numbers, steps, operations, elements, parts, or combinations thereof.

Unless otherwise defined, all terms used herein, including technical or scientific terms, have the same meaning as commonly understood by one of ordinary skill in the art to which this disclosure pertains. Terms that are defined in generally used dictionaries should be interpreted as having a meaning consistent with their meaning in the context of the related art and are not to be interpreted in an idealized or overly formal sense unless explicitly defined in the disclosure.

Meanwhile, when certain functions or operations stated in a specific block are implemented differently, they may occur in an order different from that described in the flowchart. For example, two consecutive blocks may actually be performed substantially simultaneously, or the blocks may be executed in reverse order depending on the related functions or operations.

Hereinafter, embodiments of the present disclosure will be described in more detail with reference to the accompanying drawings. In the drawings, the same reference numerals denote the same components, and redundant descriptions of the same components will be omitted.

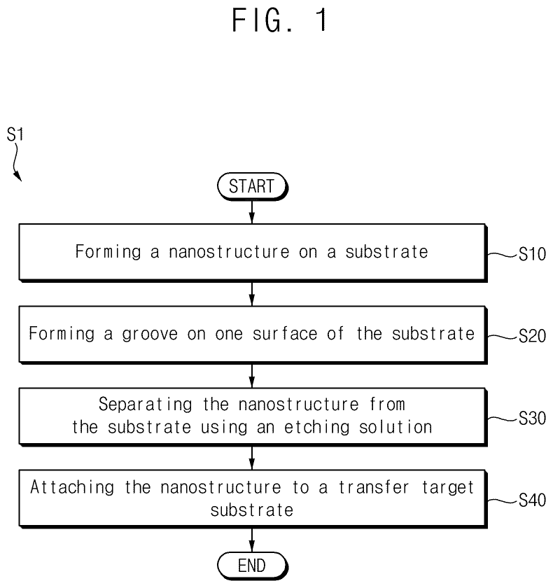

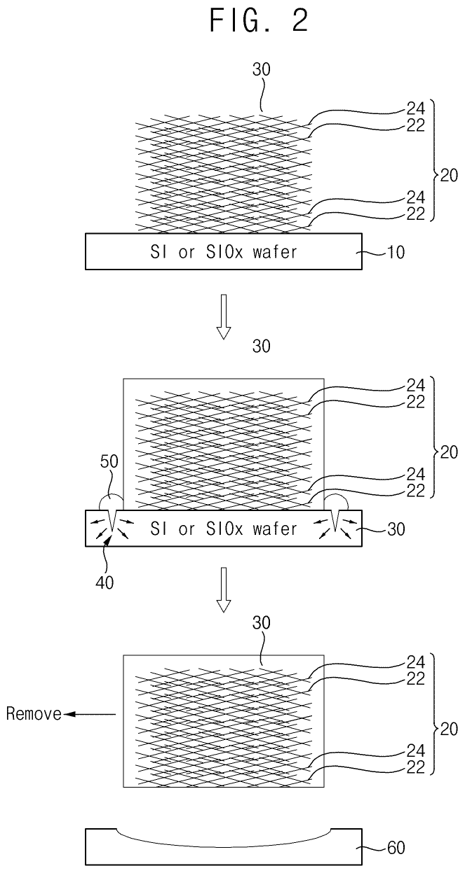

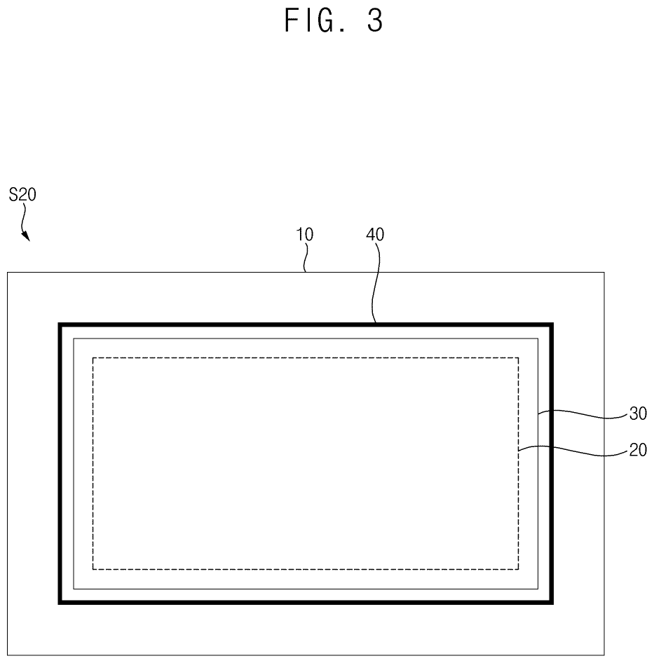

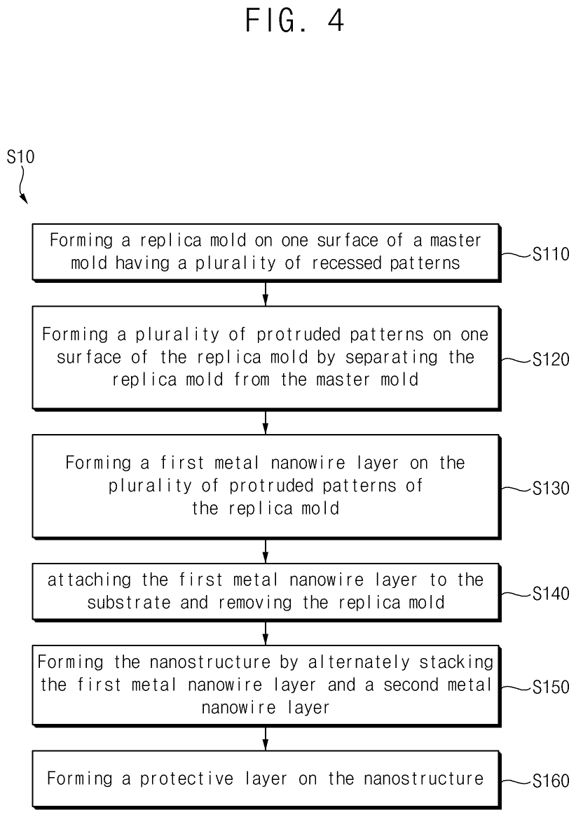

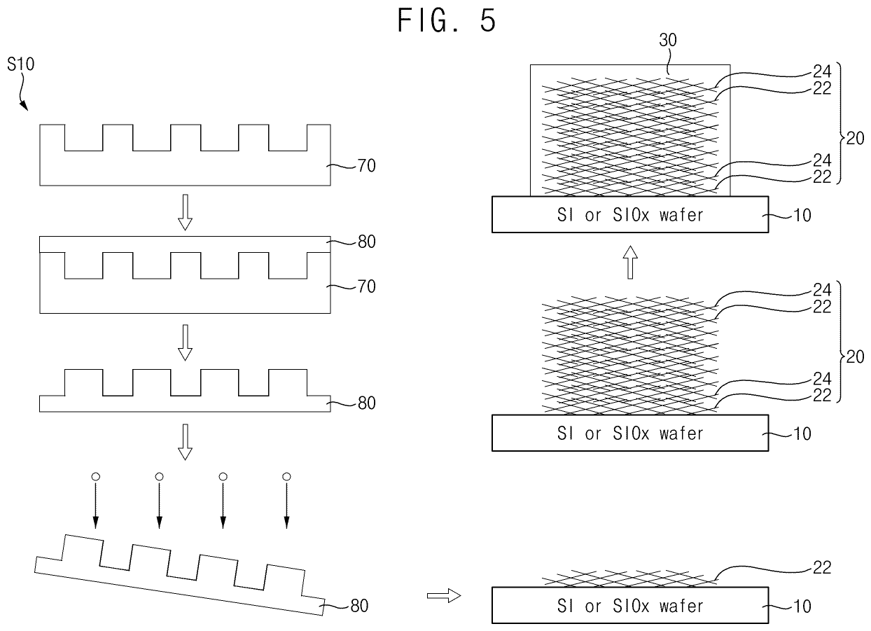

FIG. 1 is a flowchart illustrating a method for transfer of a metal nanostructured catalyst according to an embodiment of the present disclosure. FIG. 2 is a diagram for explaining the method of transfer of the metal nanostructured catalyst of FIG. 1. FIG. 3 is a plan view for explaining forming a groove on one surface of the substrate of FIG. 1. FIG. 4 is a flowchart illustrating a method for forming a nanostructure on the substrate of FIG. 1. FIG. 5 is a diagram for explaining the method for forming the nanostructure on the substrate of FIG. 1.

Referring to FIGS. 1, 2, 3, 4, and 5, the method for transfer of a metal nanostructured catalyst S1 according to an embodiment of the present disclosure may include forming a nanostructure 20 on a substrate 10 S10, forming a groove 40 on one surface of the substrate 10 S20, separating the nanostructure 20 from the substrate 10 using an etching solution 50 S30, and attaching the nanostructure 20 to a transfer target substrate 60.

That is, the method for transfer of a metal nanostructured catalyst S1 may include a method for fabrication of the nanostructure 20. In particularly, the forming the nanostructure 20 on the substrate 10 S10, the forming the groove 40 on the one surface of the substrate 10 S20, and the separating the nanostructure 20 from the substrate 10 using the etching solution 50 S30 may be referred to as the method for fabrication of the metal nanostructured catalysts.

In the disclosure, the nanostructure 20 may be referred to as the metal nanostructured catalysts.

The forming the nanostructure 20 on the substrate 10 S10 may include forming a replica mold 80 on one surface of a master mold 70 having a plurality of recessed patterns S110, forming a plurality of protruded patterns on one surface of the replica mold 80 by separating the replica mold 80 from the master mold 70 S120, forming a first metal nanowire layer 22 on the plurality of protruded patterns of the replica mold 80 S130, attaching the first metal nanowire layer 22 to the substrate 10 and removing the replica mold 80 S140, forming the nanostructure 20 by alternately stacking the first metal nanowire layer 22 and a second metal nanowire layer 24 S150, and forming a protective layer 30 on the nanostructure 20 S160.

In the replica mold 80 on the one surface of a master mold 70 having a plurality of recessed patterns S110, the master mold 70 may be fabricated through a reactive ion etching process after a photolithography process. For example, the master mold 70 may have a plurality of recessed patterns (e.g., negative patterns) formed through the photolithography process. In an embodiment, each of the plurality of recessed patterns defined on the master mold 70 may have a width of about 20 nm to about 200 nm. For example, each of the plurality of recessed patterns may be formed to be elongated in one direction to adjust alignment characteristics.

In an embodiment, the one surface of the master mold 70 may be spin-coated with a hydroxyl-terminated polymer. For example, the polymer may be a hydroxyl-terminated PDMS polydimethylsiloxane PDMS or a hydroxyl-terminated PS polystyrene. However, types of the polymer coated on the master mold 70 according to the embodiments of the present disclosure may be merely exemplary and may not be necessarily limited thereto.

In an embodiment, the method for transfer of the metal nanostructured catalyst may further include annealing the master mold 70 coated with the polymer. In an embodiment, a process of annealing the master mold 70 may be performed at about 200° C. for about 2 hours, and after the annealing process is performed, the polymer not adhered to the one surface of the master mold 70 may be cleaned with a heptane.

In the forming a plurality of protruded patterns on the one surface of the replica mold 80 by separating the replica mold 80 from the master mold 70 S120, when the replicated mold 80 coated on the one surface of the master mold 70 is separated from the master mold 70, the polymer may be used to lower surface energy so that the replicated mold 80 may be completely separated from the plurality of recessed patterns.

In an embodiment, the polymer may have a weight ratio of about 0.5 wt % to about 5 wt % in an organic solvent. Preferably, the polymer may have a weight ratio of about 1 wt % to about 2 wt % in the organic solvent. When the weight ratio of the polymer is less than about 0.5 wt %, the replicated mold 80 may not be completely separated from the master mold 70, and when the weight ratio exceeds about 5 wt %, the polymer that does not react with the master mold 70 may not be completely removed.

The replicated mold 80 may be formed on the one surface of the master mold 70. For example, after the one surface of the master mold 70 is spin-coated with the polymer, the master mold 70 may be coated with the replicated mold 80. In an embodiment, the replicated mold 80 may include an acrylic resin. In an embodiment, the replicated mold 80 may include polymethyl methacrylate PMMA, methyl acrylate, ethyl acrylate, n-butyl acrylate, t-butyl acrylate, cellulose acetate and the like. These may be used alone or in combination.

In an embodiment, the replicated mold 80 may have a weight ratio of about 1 wt % to about 10 wt % in a solvent including polymethyl methacrylate, acetone, heptane, and toluene. Preferably, the replicated mold 80 may have a weight ratio of about 3 wt % to about 5 wt % in the solvent. When the replicated mold 80 has a weight ratio of less than 1 wt %, the plurality of protruding patterns corresponding to the shapes of the plurality of recessed patterns of the master mold 70 may not be formed, and when the weight ratio exceeds 10 wt %, removal of the replicated mold 80 from the master mold 70 may be difficult.

In the forming a plurality of protruded patterns on the one surface of the replica mold 80 by separating the replica mold 80 from the master mold 70 S120, the replicated mold 80 may be separated from the master mold 70 by attaching an adhesive tape to the replicated mold 80. In an embodiment, the adhesive tape may include polyimide (PI). However, the type of adhesive tape attached to the replicated mold 80 according to the embodiments of the present disclosure may be merely exemplary and may not be necessarily limited thereto.

For example, after the adhesive tape is attached to the other surface of the replicated mold 80 opposite to the one surface facing the master mold 70, the replicated mold 80 may be separated from the master mold 70 by pulling the replicated mold 80. Specifically, after the polyimide tape is attached to the other surface of the replicated mold 80, when the tape is peeled off by pulling, the replicated mold 80 is transferred to the tape side and separated. Accordingly, the plurality of protruding patterns corresponding to the plurality of recessed patterns of the master mold 70 may be formed on the one surface of the replicated mold 80. In an embodiment, the plurality of protruding patterns may be spaced apart from each other in a plan view. For example, the plurality of protruding patterns may be arranged in a plan view at a gap of about 100 nm to about 300 nm from each other. Preferably, the gap at which the plurality of protruding patterns are arranged may be about 150 nm to about 250 nm. More preferably, the gap at which the plurality of protruding patterns are arranged may be about 200 nm.

In the forming the first metal nanowire layer 22 on the plurality of protruded patterns of the replica mold 80 S130, a metal material may be deposited toward the one surface of the replicated mold 80. For example, after positioning the replicated mold 80 such that the direction in which the metal material is deposited and the one surface of the replicated mold 80 have an inclination angle, the metal material may be deposited on the protruding patterns using an e-beam evaporator. Accordingly, the first metal nanowire layer 22 including the metal material may be formed on the protruding patterns.

In an embodiment, a plurality of metal nanowires may be aligned in the first metal nanowire layer 22. In an embodiment, the first metal nanowire layer 22 may include the plurality of metal nanowires spaced apart from each other in a plan view. Specifically, the plurality of metal nanowires may extend in a first direction parallel to the one surface of the replicated mold 80 and may be arranged to be spaced apart in a second direction crossing the first direction. For example, the first direction may be perpendicular to the second direction.

Since the first metal nanowire layer 22 has a relatively small deposition thickness compared to a case of fabricating a general metal thin film, a higher-order crystal plane may be included in the catalyst active surface, thereby suppressing a hydrogen generation reaction and increasing CO selectivity in a carbon dioxide reduction reaction.

In an embodiment, the metal material may include gold Au, silver Ag, tin Sn, copper Cu and the like. In an embodiment, the deposition rate of the metal material may be about 0.5 Å/s to about 2.0 Å/s. Preferably, the deposition rate of the metal material may be about 1.0 Å/s to about 1.9 Å/s. More preferably, the deposition rate of the metal material may be about 1.5 Å/s.

In an embodiment, the inclination angle may be about 80 °to about 90 °. Preferably, the inclination angle may be about 83 °to about 87 °. More preferably, the inclination angle may be about 85 °.

In an embodiment, the first metal nanowire layer 22 formed on the one surface of the replicated mold 80 may have a single-layered structure. However, the first metal nanowire layer 22 according to the embodiments of the present disclosure may not be necessarily limited thereto, and the first metal nanowire layer 22 formed on the one surface of the replicated mold 80 may have a multi-layered structure.

In the attaching the first metal nanowire layer 22 to the substrate 10 and the removing the replica mold 80 S140, after attaching the first metal nanowire layer 22 to the substrate 10, the replicated mold 80 may be exposed to organic solvent vapor. In an embodiment, the organic solvent vapor may include heptane, acetone and the like. Specifically, to weaken the adhesive force between the tape and the replicated mold 80, the organic solvent vapor maintained at about 45 ° C. to about 90 ° C. for at least 10 minutes may be provided for about 10 seconds to about 40 seconds to the first metal nanowire layer 22 deposited on the replicated mold 80. After the first metal nanowire layer 22 is exposed to vapor, the first metal nanowire layer 22 deposited on the replicated mold 80 may be attached to the substrate 10 and the tape may be removed. Accordingly, the first metal nanowire layer 22 and the replicated mold 80 may be transferred to the substrate 10.

After the first metal nanowire layer 22 and the replicated mold 80 are transferred to the substrate 10, the replicated mold 80 may be removed to obtain the first metal nanowire layer 22 having an aligned pattern. In an embodiment, the first metal nanowire layer 22 may be transferred onto the one surface of the substrate 10, and the plurality of metal nanowires included in the first metal nanowire layer 22 may extend in the first direction on the one surface of the substrate 10 and may be arranged to be spaced apart in the second direction. In an embodiment, the replicated mold 80 may be removed through an organic solvent such as toluene.

In an embodiment, the substrate 10 may be a silicon(Si) wafer or a silicon oxide (SiOₓ) wafer. However, types of the substrate 10 according to the embodiments of the present disclosure may not be necessarily limited thereto.

In an embodiment, a thickness of the substrate 10 may be about 500 nm to about 550 nm. For example, when the substrate 10 is the silicon (Si) wafer substrate, the thickness of the substrate 10 may be about 500 nm to about 550 nm. In another example, when the substrate 10 is the silicon oxide (SiOₓ) wafer substrate, the thickness of the substrate 10 may be about 505 nm to about 545 nm. Specifically, when the substrate 10 is a silicon oxide (SiOₓ) wafer substrate, the substrate 10 may include a silicon oxide layer and a silicon wafer layer. The silicon oxide layer may be not more than about 300 nm.

In the forming the nanostructure 20 by alternately stacking the first metal nanowire layer 22 and the second metal nanowire layer 24 S150, the second metal nanowire layer 24 may be formed on the first metal nanowire layer 22 formed on the substrate 10. Specifically, the second metal nanowire layer 24 may be formed by depositing the metal material included in the second metal nanowire layer 24 on the replicated mold 80, and the surface of the replicated mold 80 on which the second metal nanowire layer 24 is formed may be attached to the first metal nanowire layer 22. Thereafter, the replicated mold 80 may be removed with the organic solvent so that the first metal nanowire layer 22 and the second metal nanowire layer 24 may be sequentially alternately stacked on the substrate 10.

In an embodiment, a plurality of metal nanowires may be aligned in the second metal nanowire layer 24. In an embodiment, the second metal nanowire layer 24 may include the plurality of metal nanowires including the metal material. For example, the metal material may include gold (Au), silver (Ag), tin (Sn), copper (Cu) and the like.

In an embodiment, the second metal nanowire layer 24 may include a material different from a material of the first metal nanowire layer 22. For example, when the first metal nanowire layer 22 includes gold (Au), the second metal nanowire layer 24 may include copper (Cu). In another example, when the first metal nanowire layer 22 includes copper (Cu), the second metal nanowire layer 24 may include gold (Au). However, the materials included in the first metal nanowire layer 22 and the second metal nanowire layer 24 according to the embodiments of the present disclosure may be merely exemplary and may not be necessarily limited thereto.

In another embodiment, the first metal nanowire layer 22 and the second metal nanowire layer 24 may include the same material. For example, the first metal nanowire layer 22 and the second metal nanowire layer 24 may both include gold (Au) and copper (Cu).

After the second metal nanowire layer 24 is formed, the first metal nanowire layer 22 and the second metal nanowire layer 24 may be alternately stacked. Accordingly, the nanostructure 20 in which the first metal nanowire layer 22 and the second metal nanowire layer 24 are alternately stacked may be fabricated. The nanostructure 20 may be a catalyst used for a carbon dioxide reduction reaction.

In an embodiment, a direction in which the metal nanowires included in the first metal nanowire layer 22 extend and a direction in which the metal nanowires included in the second metal nanowire layer 24 extend may intersect with each other. For example, an angle formed between the direction in which the metal nanowires included in the first metal nanowire layer 22 extend and the direction in which the metal nanowires included in the second metal nanowire layer 24 extend may be about 70° to about 90°. Preferably, the angle formed between the direction in which the metal nanowires included in the first metal nanowire layer 22 extend and the direction in which the metal nanowires included in the second metal nanowire layer 24 extend may be about 80° to about 90°.

Accordingly, sufficient space may be secured between the metal nanowires arranged in different layers, and the secured space may be filled with an electrolyte to increase catalyst utilization efficiency and allow reactants and products inside the catalyst to move easily. In addition, by the secured space in the fabricated nanostructure 20, a local pH of the electrode surface may increase to suppress a hydrogen evolution reaction and increase CO selectivity.

In an embodiment, the thickness of each of the first metal nanowire layer 22 and the second metal nanowire layer 24 may be about 30 nm or more to about 100 nm. Preferably, the thickness of each of the first metal nanowire layer 22 and the second metal nanowire layer 24 may be about 30 nm or more to about 50 nm. In an embodiment, the number of stacked layers of the first metal nanowire layer 22 and the second metal nanowire layer 24 in the nanostructure 20 may be about 10 or more to about 50 or more. Preferably, the number of stacked layers of the first metal nanowire layer 22 and the second metal nanowire layer 24 in the nanostructure 20 may be about 15 or more to about 30 or more. However, the number of stacked layers of the first metal nanowire layer 22 and the second metal nanowire layer 24 in the nanostructure 20 according to the embodiments of the present disclosure may not be necessarily limited thereto.

In the forming the protective layer 30 on the nanostructure 20 S160, the protective layer 30 may be coated on the upper portion of the nanostructure 20. For example, the protective layer 30 may be spin-coated on the upper portion and the side portion of the nanostructure 20. In an embodiment, the protective layer 30 may include an organic material. For example, the organic material may include an acrylic resin. For example, the acrylic resin may include polymethyl methacrylate, methyl acrylate, ethyl acrylate, n-butyl acrylate, t-butyl acrylate and the like. These may be used alone or in combination with each other.

In an embodiment, the protective layer 30 may be formed by spin-coating a solution including the acrylic resin. In an embodiment, the solution may be in a state in which the acrylic resin is included in a solvent including acetone, toluene, and heptane. For example, the acrylic resin included in the solution may have a weight ratio of about 3 wt % to about 5 wt %. Preferably, the acrylic resin included in the solution may have a weight ratio of about 4 wt %. For example, the volume ratio of acetone, toluene, and heptane in the solution may be about 4:4:2 to about 4.5:4.5:1.

In an embodiment, the thickness of the protective layer 30 may be about 100nm or more to about 400 nm. Preferably, the thickness of the protective layer 30 may be about 200 nm or more to about 300 nm.

In the forming the groove 40 on the one surface of the substrate 10 S20, the groove 40 may be formed in a portion adjacent to the nanostructure 20 of the substrate 10. In an embodiment, the groove 40 may have a recessed negative pattern shape recessed in a thickness direction of the substrate 10. In an embodiment, the groove 40 may be formed by generating fine damage on the one surface of the substrate 10 using a cutting device such as a diamond cutter. However, the device for forming the groove 40 according to the embodiments of the present disclosure may be merely exemplary and may not be necessarily limited thereto.

In an embodiment, the groove 40 may surround at least a portion of the nanostructure 20 and the protective layer 30 in a plan view. For example, the groove 40 may entirely surround the protective layer 30 in a plan view. Specifically, the groove 40 may be formed by moving the diamond cutter along the boundary of the protective layer 30 such that friction occurs on the one surface of the substrate 10. When the groove 40 partially surrounds the protective layer 30 without completely surrounding the protective layer 30, a speed at which the nanostructure 20 is separated from the substrate 10 in the separating the nanostructure 20 from the substrate 10 using an etchant 50 S30 may be relatively slow.

In an embodiment, on the one surface of the substrate 10, the groove 40 may be formed at a position adjacent to the nanostructure 20. For example, the groove 40 may be adjacent to an edge portion of the nanostructure 20. In an embodiment, the thickness of the groove 40 may be not more than about 50 μm.

In an embodiment, a shortest distance between the boundary of the protective layer 30 and the groove 40 in a plan view may be about 2 mm or less. When the shortest distance between the boundary of the protective layer 30 and the groove 40 exceeds 2 mm, the speed at which the nanostructure 20 is separated from the substrate 10 in step S30 of separating the nanostructure 20 from the substrate 10 using the etchant 50 may be relatively slow. In addition, as the shortest distance between the boundary of the protective layer 30 and the groove 40 approaches 0 in a plan view, the speed at which the nanostructure 20 is separated from the substrate 10 in the separating the nanostructure 20 from the substrate 10 using the etchant 50 S30 may be relatively fast.

In the separating the nanostructure 20 from the substrate 10 using the etchant 50 S30, the etchant 50 may be applied toward the one surface of the substrate 10. Specifically, the etchant 50 may fill a portion of the substrate 10 recessed by the groove 40, and accordingly, the etchant 50 may remove the inside of the substrate 10. In other words, the groove 40 may be formed so that the etchant 50 rapidly diffuses into the inside of the substrate 10 to easily separate the nanostructure 20 from the substrate 10.

In an embodiment, the etchant 50 may be a buffered oxide etch (BOE) solution or a potassium hydroxide (KOH) aqueous solution. For example, when the substrate 10 is a silicon oxide wafer, the etchant 50 may be the BOE solution. In another example, when the substrate 10 includes a silicon wafer, the etchant 50 may be a potassium hydroxide (KOH) aqueous solution. Specifically, the potassium hydroxide KOH aqueous solution may have a weight ratio of about 20 wt % to about 40 wt %. Preferably, the potassium hydroxide KOH aqueous solution may have a weight ratio of about 30 wt % to about 35 wt %. However, the type of the etchant 50 according to the embodiments of the present disclosure may be merely exemplary and may not be necessarily limited thereto. In an embodiment, a volume of the etchant 50 may be about 3 ml or more. Preferably, the volume of the etchant 50 may be about 5 ml.

A portion of the substrate 10 adjacent to the edge portion of the nanostructure 20 covered with the protective layer 30 may be etched first through the etchant 50, and thereafter, the etchant 50 may diffuse from the groove 40 so that a portion of the substrate 10 in contact with the nanostructure 20 is removed. Accordingly, the nanostructure 20 separated from the substrate 10 may float on the etchant 50, and the nanostructure 20 may be lifted from the etchant 50 and obtained.

In the attaching the nanostructure 20 to the transfer target substrate 60 S40, the nanostructure 20 separated from the substrate 10 may be obtained and the nanostructure 20 may be placed into a deionized water (DI) water solution. The nanostructure 20 may float in the deionized water solution.

The nanostructure 20 and the transfer target substrate 60 may be brought into contact with each other in the deionized water solution. For example, the transfer target substrate 60 may be placed below the nanostructure 20 floating in the deionized water solution to bring the nanostructure 20 and the transfer target substrate 60 into contact with each other. In an embodiment, the transfer target substrate 60 may be a metal electrode or an ion exchange membrane included in a cell for a carbon dioxide reduction reaction.

After the nanostructure 20 and the transfer target substrate 60 are brought into contact with each other, the nanostructure 20 and the transfer target substrate 60 may be dried. For example, moisture existing between the nanostructure 20 and the transfer target substrate 60 may be removed using a blower, and accordingly, the nanostructure 20 may be completely attached to or transferred to the transfer target substrate 60.

In an embodiment, after the attaching the nanostructure 20 to the transfer target substrate 60 S40, the protective layer 30 covering the nanostructure 20 may be removed. For example, the protective layer 30 may be removed through an organic solvent such as toluene. Accordingly, a metal catalyst structure or a metal catalyst electrode having a three-dimensional nanostructure transferred to the transfer target substrate 60 may be fabricated.

As described above, in the method for transfer of the metal nanostructured catalyst S1 according to an embodiment of the present disclosure, the groove 40 adjacent to the nanostructure 20 may be formed on the one surface of the substrate 10, and the etchant filling the groove 40 may be applied. Accordingly, since the etchant diffusing along the groove 40 may remove a portion of the substrate 10 in contact with the nanostructure 20 without inserting the substrate 10 and the nanostructure 20 into a container filled with the etchant, the substrate 10 may be easily removed from the nanostructure 20. Therefore, process time and cost required for obtaining the nanostructure 20 used in the metal catalyst structure for carbon dioxide reduction may be reduced.

In addition, since the substrate 10 may be easily removed by forming the groove 40, a substrate 10 of a metal or metal oxide including copper may be used. Accordingly, types of substrates 10 used to fabricate the metal catalyst structure may not be limited, and since an etchant for etching copper is not used, the nanostructure 20 may include copper. Therefore, the metal catalyst structure having high efficiency and high selectivity may be easily fabricated.

In the present specification, the forming the nanostructure 20 on the substrate 10 S10, the forming the groove 40 on the one surface of the substrate 10 S20, and the separating the nanostructure 20 from the substrate 10 using the etchant 50 S30 may be referred to as a method for fabrication of the metal nanostructured catalyst.

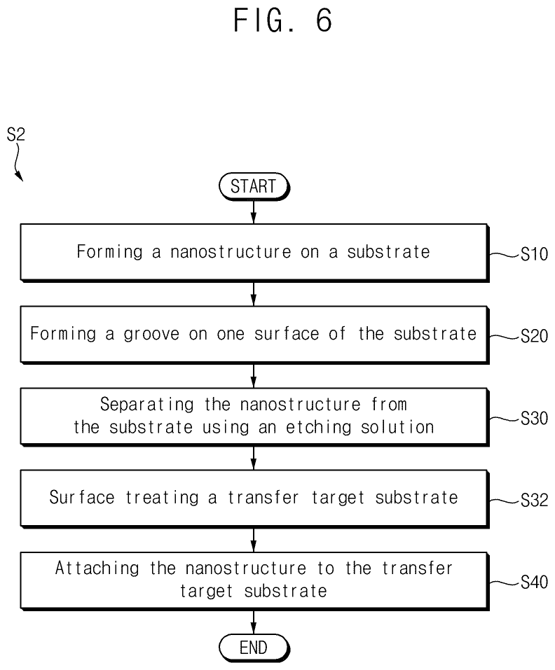

FIG. 6 is a diagram illustrating a method for transfer of the metal nanostructured catalyst according to another embodiment of the present disclosure.

A method for transfer of the metal nanostructured catalyst S2 described with reference to FIG. 6 may be substantially the same as or similar to the method for transfer of the metal nanostructured catalyst described with reference to FIGS. 1, 2, 3, 4, and 5, except that surface treating the transfer target substrate 60 S32 is further included. Hereinafter, contents overlapping those described with reference to FIGS. 1, 2, 3, 4, and 5 may be omitted or briefly described.

Referring to FIGS. 2, 3, 4, 5, and 6, the method for transfer of the metal nanostructured catalyst S2 according to another example of the present disclosure may include surface treating the transfer target substrate 60 S32. In an embodiment, the transfer target substrate 60 may be a gas diffusion layer, GDL, having strong hydrophobicity and included in a cell for carbon dioxide reduction reaction. For example, the gas diffusion layer having strong hydrophobicity may be carbon paper, poly tetra fluoroethylene, PTFE, and the like.

In an embodiment, the surface treating the transfer target substrate 60 S32, a surface treatment such as an oxygen plasma process may be performed on the gas diffusion layer such that hydroxyl groups are formed on the transfer target substrate 60. A hydrophilic polymer brush may be coated on the transfer target substrate 60 on which the surface treatment has been performed. Thereafter, the transfer target substrate 60 may be introduced into the deionized water solution to contact the nanostructure 20, and the nanostructure 20 and the transfer target substrate 60 may be dried together so that the nanostructure 20 may be completely attached to, or transferred to, the transfer target substrate 60. Thereafter, the protection layer 30 covering the nanostructure 20 may be removed. Accordingly, the metal catalyst structure having a three-dimensional nanostructure transferred to the transfer target substrate 60 may be fabricated.

As described above, in the method for transfer of the metal nanostructured catalyst S2 according to an embodiment of the present disclosure, the groove 40 adjacent to the nanostructure 20 may be formed on the one surface of the substrate 10, and the etchant filling the groove 40 may be applied. Accordingly, even without introducing the substrate 10 and the nanostructure 20 into a container containing the etchant, the etchant diffused along the groove 40 may remove a portion of the substrate 10 that contacts the nanostructure 20, so that the substrate 10 may be easily removed from the nanostructure 20. Therefore, process time and cost for obtaining the nanostructure 20 used in a metal catalyst structure for carbon dioxide reduction may be reduced.

In addition, since the substrate 10 may be easily removed by forming the groove 40, a substrate 10 of a metal or a metal oxide including copper may be used. Accordingly, the type of the substrate 10 used for fabricating the metal catalyst structure may not be limited, and since an etchant for etching copper is not used, the nanostructure 20 may include copper. Therefore, the metal catalyst structure having high efficiency and high selectivity may be easily fabricated.

In addition, when the transfer target substrate 60 is a gas diffusion layer having hydrophobicity, surface treatment may be performed to provide hydroxyl groups on the surface of the transfer target substrate 60. Accordingly, the nanostructure 20 may be easily attached or transferred to the gas diffusion layer.

In the disclosure, the forming the nanostructure 20 on the substrate 10 S10, the forming the groove 40 on the one surface of the substrate 10 S20, and the separating the nanostructure 20 from the substrate 10 by using the etchant 50 S30 may be referred to as the method for fabrication of the metal nanostructured catalyst.

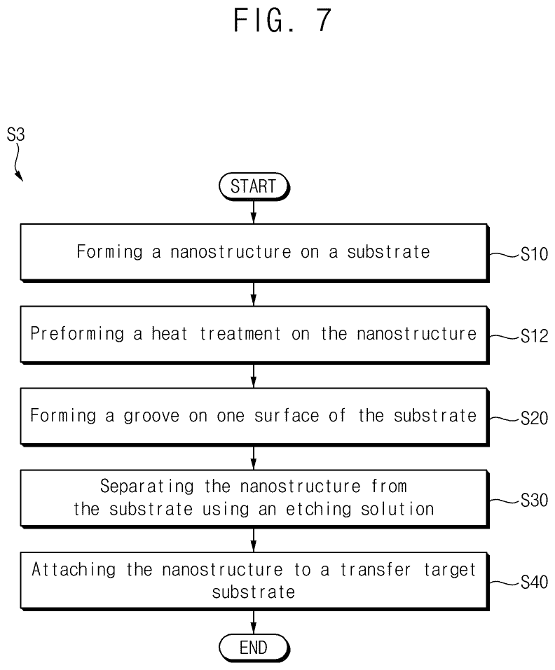

FIG. 7 is a diagram illustrating a method for transfer of the metal nanostructured catalyst according to still another embodiment of the present disclosure.

A method for transfer of the metal nanostructured catalyst S3 described with reference to FIG. 7 may be substantially the same as or similar to method for transfer of the metal nanostructured catalyst S1 described with reference to FIGS. 1, 2, 3, 4, and 5, except that performing a heat treatment on the nanostructure 20 S12 is further included. Hereinafter, contents overlapping those described with reference to FIGS. 1, 2, 3, 4, and 5 may be omitted or briefly described.

Referring to FIGS. 2, 3, 4, 5, and 7, the method for transfer of the metal nanostructured catalyst S3 according to still another embodiment of the present disclosure may further include performing the heat treatment on the nanostructure 20 S12, which is performed between the forming the nanostructure 20 on the substrate 10 S10 and the forming the groove 40 on the one surface of the substrate 10 S20.

In the performing the heat treatment on the nanostructure 20 S12, the heat treatment may be performed for crystallization of the metal nanowires included in the nanostructure 20. In an embodiment, the heat treatment may be performed at about 400° C. to about 800° C. Preferably, the heat treatment may be performed at about 500° C. to about 700° C. In an embodiment, the heat treatment may be performed for about 5 minutes to about 3 hours. Preferably, the heat treatment may be performed for about 1 hour to about 2 hours.

However, the method for transfer of the metal nanostructured catalyst S3 according to embodiments of the present disclosure is not limited thereto, and the transfer method S3 of the metal nanostructured catalyst may further include the surface treating the transfer target substrate 60 S32 of FIG. 6.

As described above, in the method for transfer of the metal nanostructured catalyst S3 according to an embodiment of the present disclosure, the groove 40 adjacent to the nanostructure 20 is formed on the one surface of the substrate 10, and the etching solution filling the groove 40 may be applied. Accordingly, even without immersing the substrate 10 and the nanostructure 20 into a container filled with the etching solution, the etching solution diffusing along the groove 40 may remove a portion of the substrate 10 in contact with the nanostructure 20, thereby easily removing the substrate 10 from the nanostructure 20. Therefore, the process time and cost for obtaining the nanostructure 20 used for the metal catalyst structure for carbon dioxide reduction may be reduced.

In addition, since the substrate 10 may be easily removed by forming the groove 40, the substrate 10 of metal or metal oxide including copper may be used. Accordingly, the type of the substrate 10 used for fabricating the metal catalyst structure may not be limited, and since an etching solution for etching copper may not be used, the nanostructure 20 may include copper. Therefore, the metal catalyst structure having high efficiency and high selectivity may be easily fabricated.

In addition, since the type of the substrate 10 used for fabricating the metal catalyst structure may not be limited, the heat treatment may be performed on the nanostructure 20 before forming the groove 40. Accordingly, the crystallinity of the nanostructure 20 may be improved. Therefore, the performance of the metal catalyst structure for carbon dioxide reduction fabricated from the nanostructure 20 may be improved.

In the present specification, the forming the nanostructure 20 on the substrate 10 S10, the performing heat treatment on the nanostructure 20 S12, the forming the groove 40 on the one surface of the substrate 10 S20, and the separating the nanostructure 20 from the substrate 10 using the etching solution 50 S30 may be referred to as the method for fabrication of the metal nanostructured catalyst.

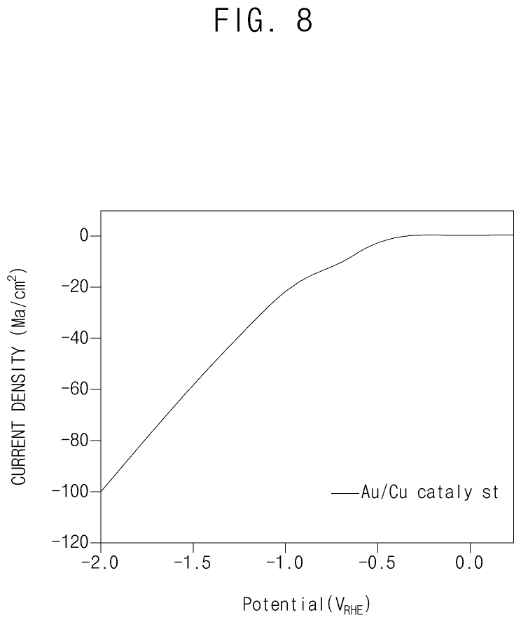

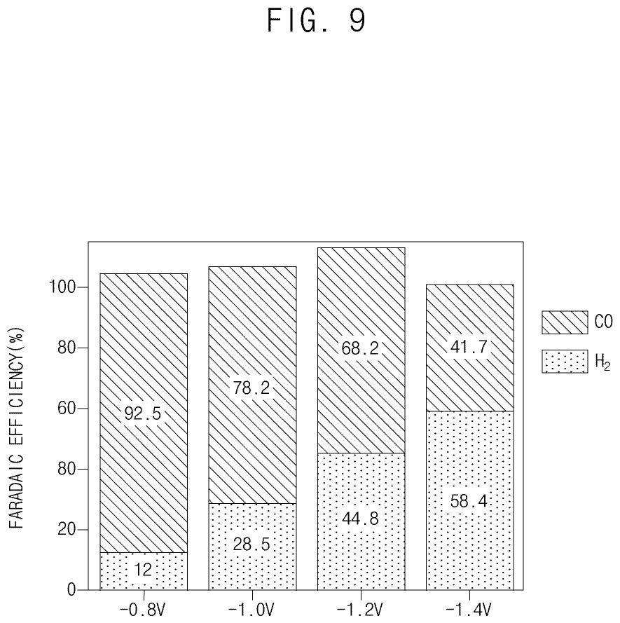

FIG. 8 is a graph illustrating electrical characteristics of a fabrication example fabricated according to the method for fabrication and transfer of the metal nanostructured catalyst of the present disclosure. FIG. 9 is a graph illustrating carbon dioxide reduction efficiency of the fabrication example of FIG. 8.

Hereinafter, performance evaluation of the following fabrication examples will be described to explain the effects of the present disclosure.

### Fabrication Example

Referring to FIGS. 8 and 9, a total of twenty nanostructure layers were formed by alternately stacking a copper nanowire layer including copper (Cu) and a gold nanowire layer including gold (Au) by incidentally depositing a deposition material toward an upper surface of the silicon wafer substrate so that an incident angle of the deposition material emitted from the electron-beam evaporator e-beam evaporator and the upper surface of the silicon wafer substrate formed an angle of 85°, and the upper portion and the side portion of the nanostructure were coated with a PMMA coating film, and a groove on the portion of the silicon wafer surrounding the boundary of the PMMA coating film in a plan view was formed, the nanostructure was separated from the silicon wafer by applying 30 wt % potassium hydroxide KOH, the nanostructure onto PiperION® which is an exchange membrane was transferred, and the metal nanostructure catalyst according to the fabricated example was fabricated.

At this time, a width of the deposition material incident from the electron-beam evaporator was 30 nm, and due to an inclined angle of the silicon wafer, one nanowire included in each of the copper nanowire layers and the gold nanowire layers deposited on the silicon wafer had a width of 60 nm, and a gap between the nanowires arranged in the same layer was 400 nm.

In one flow cell, the metal nanostructure catalyst in which the nanostructure according to the fabrication example was transferred onto the exchange membrane, an electrolyte having a pH of 7.5 and including 1.0 M KHCO₃ with carbon dioxide gas bubbled therein, a counter electrode of nickel foam Ni foam, and a reference electrode of a reverse hydrogen electrode RHE were arranged, and the metal nanostructure catalyst in which the nanostructure according to the fabrication example was transferred onto the exchange membrane was used as a working electrode. The voltage was varied from 0 V to −2 V for 30 minutes, and as illustrated in FIG. 9, the amount of carbon monoxide CO and the amount of hydrogen H₂ generated from the catalyst for 30 minutes, and the current density graph with respect to the voltage potential of the reference electrode, were measured.

As illustrated in FIG. 8, a magnitude of the current density was proportional to the magnitude of the voltage potential of the reference electrode, and as illustrated in FIG. 9, at a potential of −0.8 V, the ratio of the amount of carbon monoxide to the total amount of products indicating the degree of reduction of carbon dioxide was measured to be 92.5%. Accordingly, the metal nanostructure catalyst fabricated and separated from the substrate according to the fabricating and transfer method of the metal nanostructure catalyst according to embodiments of the present disclosure, despite including copper Cu, which is a metal material that is difficult to transfer, may be confirmed to have high selectivity and high efficiency in the carbon dioxide reduction reaction.

The method for fabrication of the metal nanostructured catalyst and the method for transfer of the metal nanostructured catalyst including the same according to exemplary embodiments of the present disclosure may be used for a catalyst for carbon dioxide reduction, a battery including the same, an electronic device, a plant, and the like.

While exemplary embodiments of the present disclosure have been described above with reference to the drawings, it will be understood by those skilled in the art that the disclosure may be modified and changed in various ways without departing from the spirit and scope of the disclosure as set forth in the following claims.

What is claimed is:

1. A method for fabrication of a metal nanostructured catalyst, the method comprising:
forming a nanostructure including a plurality of metal nanowires aligned on a substrate;
forming a protective layer including an organic material on the nanostructure;
forming a groove adjacent to the nanostructure on one surface of the substrate on which the nanostructure is formed; and
separating the nanostructure from the substrate by applying an etching solution on the one surface of the substrate to fill the groove.

2. The method of claim 1, wherein in the separating the nanostructure from the substrate,
a portion of the substrate in contact with the nanostructure is removed through the etching solution.

3. The method of claim 1, wherein the nanostructure includes copper (Cu),
wherein the substrate is a silicon (Si) wafer substrate, and
wherein the etching solution is an aqueous potassium hydroxide (KOH) solution.

4. The method of claim 1, wherein the substrate is a silicon oxide (SiOₓ) wafer substrate, and
wherein the etching solution is a buffered oxide etchant (BOE).

5. The method of claim 1, wherein in the forming the groove adjacent to the nanostructure,
the groove is formed to entirely surround a boundary of the protective layer in a plan view.

6. The method of claim 1, wherein in the forming the groove adjacent to the nanostructure,
a shortest distance between the groove and a boundary of the protective layer in a plan view is about 2 mm or less.

7. The method of claim 1, wherein the forming the nanostructure includes:
forming an acrylic resin on a master mold having a plurality of recessed patterns;
forming a plurality of protruded patterns corresponding to the plurality of recessed patterns on the acrylic resin by separating the acrylic resin from the master mold;
forming a first metal nanowire layer in which a plurality of metal nanowires are aligned on the plurality of protruded patterns of the acrylic resin;
attaching the first metal nanowire layer to the substrate and removing the acrylic resin from the first metal nanowire layer; and
alternately stacking a second metal nanowire layer including a material different from a material of the first metal nanowire layer on the substrate together with the first metal nanowire layer.

8. The method of claim 7, wherein each of the plurality of metal nanowires included in the first metal nanowire layer includes a gold (Au), and
wherein each of the plurality of metal nanowires included in the second metal nanowire layer includes a copper (Cu).

9. The method of claim 7, wherein a direction in which each of the plurality of metal nanowires included in the first metal nanowire layer extends and a direction in which each of the plurality of metal nanowires included in the second metal nanowire layer extends form an angle of about 80° to about 90° in a plan view.

10. The method of claim 1, wherein in the forming the protective layer,
the protective layer is formed by coating the nanostructure with a solution including an acrylic resin having a weight ratio of about 3 wt % to about 5 wt % in a solvent in which the volume ratio of acetone, toluene, and heptane is about 4:4:2 to about 4.5:4.5:1.

11. The method of claim 1, wherein the protective layer includes at least one selected from a group consisting of a polymethyl methacrylate (PMMA), a methyl acrylate, an ethyl acrylate, a n-butyl acrylate, a t-butyl acrylate, and cellulose acetate.

12. The method of claim 1, further comprising:
performing a heat treatment on the nanostructure,
wherein the performing the heat treatment is performed between the forming the nanostructure and the forming the groove.

13. The method of claim 12, wherein in the performing the heat treatment,
the heat treatment is performed at a temperature range of about 500°C. to about 700°C. for about 5 minutes to 2 hours.

14. A method for transfer of the metal nanostructured catalyst, the method comprising:
forming a nanostructure including a plurality of metal nanowires aligned on a substrate;
forming a protective layer including an organic material on the nanostructure;
forming a groove adjacent to the nanostructure on one surface of the substrate on which the nanostructure is formed;
separating the nanostructure from the substrate by applying an etching solution on the one surface of the substrate to fill the groove; and
attaching the separated nanostructure to a transfer target substrate.

15. The method of claim 14, wherein the attaching the separated nanostructure to a transfer target substrate includes:
introducing the nanostructure into a deionized water (DI water) solution;
introducing the transfer target substrate into the deionized water solution so that the transfer target substrate is in contact with the nanostructure from below the nanostructure; and
drying the nanostructure and the transfer target substrate.

16. The method of claim 15, wherein attaching the separated nanostructure to a transfer target substrate further includes:
surface treating the transfer target substrate so that hydroxyl groups are formed on the surface of the transfer target substrate before introducing the transfer target substrate into the deionized water solution.

17. The method of claim 14, wherein the substrate is a silicon (Si) wafer substrate, and
wherein an etching solution is an aqueous potassium hydroxide (KOH) solution.

18. The method of claim 14, wherein the nanostructure includes copper (Cu),
wherein the substrate is a silicon oxide (SiOₓ) wafer substrate, and
wherein the etching solution is a buffered oxide etchant.

19. The method of claim 14, wherein in the forming the groove adjacent to the nanostructure,
the groove is formed to entirely surround a boundary of the protective layer in a plan view.

20. A metal nanostructured catalyst comprising:
a first metal nanowire layer including a plurality of metal nanowires spaced apart from each other in a plan view and containing copper (Cu); and
a second metal nanowire layer including a plurality of metal nanowires spaced apart from each other in a plan view and containing gold (Au),
wherein the first metal nanowire layer and the second metal nanowire layer are alternately stacked in multiple layers.
